(19) United States
(12) Patent Application Publication
(10) Pub. No.: US 2008/0005531 A1
(43) Pub. Date: Jan. 3, 2008

(54) Data Storage Device

(75) Inventor: Dennis Praca, Luynes (FR)

Correspondence Address: BUCHANAN, INGERSOLL & ROONEY PC, POST OFFICE BOX 1404, ALEXANDRIA, VA, 22313-1404, US

(73) Assignee: GEMPLUS, GEMENOS (FR)

(21) Appl. No.: 11/794,815

(22) PCT Filed: Nov. 15, 2005
(86) PCT No.: PCT/EP05/55972

§ 371 Date: Jul. 6, 2007

(30) Foreign Application Priority Data
Jan. 6, 2005 (FR) 0500109

(51) Int. Cl. G06F 9/26

(52) U.S. Cl. 711/209

(57) ABSTRACT

The invention relates to a data storage device (10) comprising a memory space (20) divided into memory blocks and an internal file system management means (30) which organises said memory blocks for storing data in a form of a file structure according to a file-type control format, wherein said device is characterised in that it comprises a protocol conversion interface (80) between said file system management means (30) and a host device (40) which is provided with means (70) for accessing to data in the storage device according to a block-type control format.

The present invention relates generally to the field of digital data storage systems.

It relates more particularly to a data storage device that includes means for managing the security of the data contained in the device at data file level.

Currently, most semiconductor memory cards (SmartMedia Cards (SMCs), CompactFlash (CF) cards, Secure Digital (SD) cards, etc.), and magnetic storage devices of the hard disk type have storage space that is subdivided into blocks. Thus, when such storage devices co-operate with a host device, it is said host device that handles management of the memory blocks so as to be able to store and organize the data, typically in the form of a system of files. For this purpose, the interface between the storage device and the host device implements a protocol conventionally based on block-type commands for reading data blocks from the memory and for writing data blocks therein. A block-type command used for erasing a data block from the memory can also be provided.

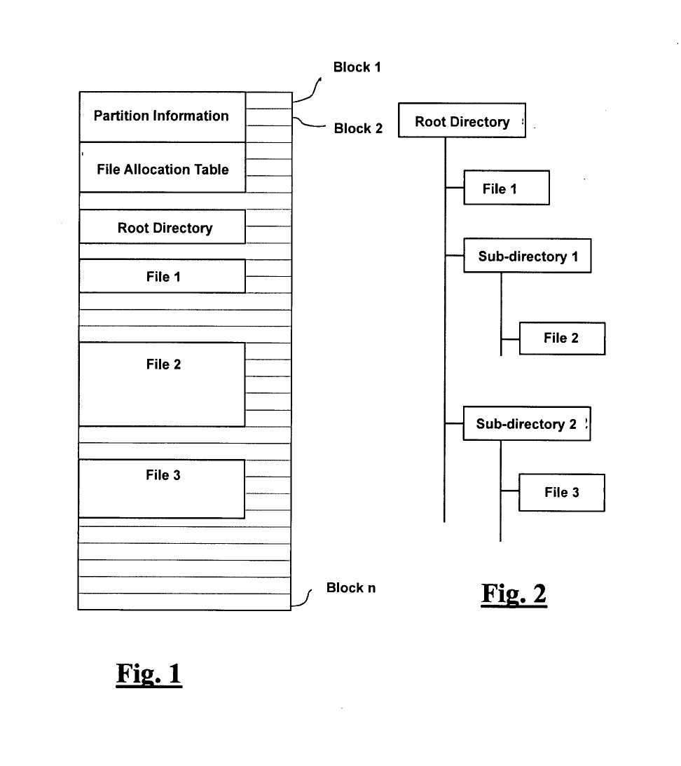

FIG. 1 thus shows, as seen from the host device, the memory organization of a storage device to which access is made via memory block read and write commands, with, in this example, the partition information, the File Allocation Table (FAT), the root directory, and the files 1, 2, 3, written in the various memory blocks referenced 1 to n. FIG. 1 thus shows how the data is physically organized in the memory so that the files can be managed and manipulated.

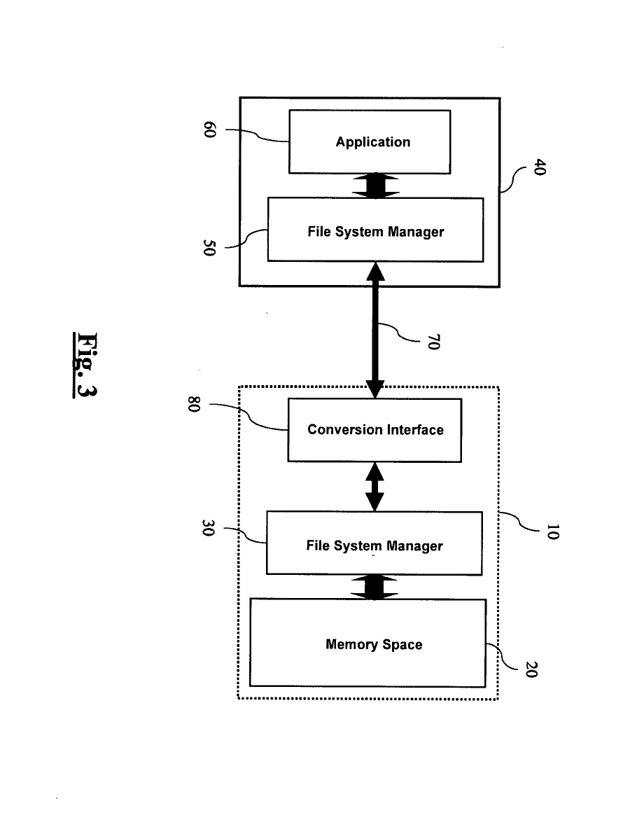

Based on this formatting of the memory space of the storage device, the host device is then capable of retrieving a structure of files. More particularly, the operating system of the host device handles managing the memory blocks formatted in this way so as to enable applications to use a file system, e.g. in the form a logic tree structure in which the files are organized hierarchically in a set of directories and of subdirectories, as shown in FIG. 2. The file system thus makes it possible to mask the underlying physical organization of the memory that is used.

In order to construct and to organize such a file system, host devices thus access the memory through block read and block write commands. As a result, the storage device itself has no control over access to the files in its memory, unless it locks access at memory block level, without however that having any relation to the files. Rights of access to the memory in this type of storage device are thus currently managed at the level of all of the blocks present or on group of blocks with it then being necessary to fragment the memory space into a plurality of groups of blocks having different access rights.

In addition to that aspect relating to the storage device being incapable of controlling access to the memory at file level, the problem posed by such block-type memory management is that it does not make it possible to take account of the specificities of memory type in managing the blocks. For example, it is known that memory cards of the Flash type withstand only a limited number of erase/write cycles. Thus, it can be advantageous to organize the file system while taking account of that characteristic and thus while avoiding storing information that is subject to frequent modification at a fixed place in the memory (this applies, for example, to File Allocation Files in FAT systems). In order to avoid that type of memory seeing its life limited by that phenomenon of certain blocks ageing, one prior art solution makes provision for the storage devices including them to add a software layer commonly referred to as a “Flash Translation Layer”, provided for virtualizing the memory addresses of the memory blocks that are visible from outside the storage device so as to be able to store information subject to frequent modification at physical addresses that are different each time writing is performed.

Unfortunately, such storage devices are limited when they are used with host devices that manage block-type access whenever it is desired to make them more intelligent, in particular by adding to them security characteristics that are more advanced for managing rights of access to data in their memories. Management of access rights on that that type of device can be performed only at the level of the blocks present in the memory.

Conversely, on storage devices of the smart card type, having embedded Electrically Erasable Programmable Read-Only Memories (EEPROMs), management of rights of access to data contained in the memories is performed at the level of the data files. In other words, this type of storage device manages its own file system. Thus, access to the smart card by the host device and control of access to the data are designed to take place at file level, through file-type commands, making it possible to open, read, and write files. This type of data access is thus much more advantageous from the point of view of managing security for access to data in the memory, compared with the above-mentioned storage devices in which access takes place through block read and block write commands, since it makes it possible to achieve very fine and very flexible security control as a function of the desired application. It is possible to provide as many different data access conditions as there are files in the storage device.

In which case, the host device has no vision over the organization of the internal memory in the card, and it must have an adapted interface with the card that is capable of implementing a file-type access protocol for accessing the data in the card. Therefore, smart card type storage devices cannot cooperate with host devices that are designed to manage block-type memories.

The two above-mentioned technologies for accessing the memory space of a storage device cooperating with a host device, one of which technologies is based on block read and block write commands, and the other of which technologies is based on file read and file write commands, thus require different interfaces, implementing protocols that are either of block type or of file type, making those two technologies mutually incompatible.

Thus, for example, it is impossible for a storage device of the smart card type having its own file manager requiring file-type memory access management to be used in a host device designed to manage memories of the block type. In addition, because of the differences between the interface structures of the block type and of the file type, and because of the way in which the data is stored and accessed, a storage device is structured either for a block-type access system or for a file-type access system, but not for both types of access system.

If it is desired to make data storage devices more advanced by enabling their memories to be managed more finely and more securely, it is necessary for such devices to manage their own file systems as in devices of the smart card type, so that management of security of data contained in the device takes place at data file level. Such upgrading for obtaining more advanced devices then comes up against the problem of compatibility with existing host devices that are designed to manage block-type memories.

An object of the present invention is thus to reconcile the two above-mentioned types of memory management technology by proposing a storage device that enables access to data contained in the memory to be controlled at file level, while also being capable of co-operating with a host device that uses a standard interface with a block-type command format.

To this end, the invention provides a data storage device comprising a memory space subdivided into memory blocks and management means for managing an internal file system organizing said memory blocks so as to store data in the form of a structure of files, said management means controlling access to the data in the memory using a file-type command format, said data storage device being characterized in that it further comprises a protocol conversion interface between said management means for managing the file system and a host device including means for accessing the data in the memory of said storage device using a block-type command format.

In an embodiment, the protocol conversion interface includes means for acting on the basis of the logic organization of the internal file system to simulate a block-type memory image of the files that are accessible by said host device, said image being visible by said host device.

Advantageously, the protocol conversion interface includes means for translating block-type commands received from the host device into file-type commands whose destination is the management means for managing the file system.

Preferably, the means for translating block-type commands into file-type commands include means for determining the type of block accessed from among a system zone, a File Allocation Table (FAT) zone, and a file zone of the internal file system.

Advantageously, the protocol conversion interface includes means for transmitting firstly the translated block-type commands to the file system management means and secondly corresponding block-type responses to the host device.

In an embodiment, the protocol conversion interface includes means for constructing the block-type responses as a function of access rights associated with the host device.

Advantageously, the protocol conversion interface includes means for modifying the data accessed by the host device as a function of the type of data accessed and/or of access rights associated with the host device.

Preferably, the protocol conversion interface is in software form under the control of the file system management means.

Other characteristics and advantages of the present invention appear more clearly on reading the following description given by way of non-limiting example and with reference to the accompanying drawings, in which:

FIG. 1 (described above) is a diagram showing the physical organization of data in a block-type memory;

FIG. 2 (describe above) is a diagram showing the logic organization of a file system; and

FIG. 3 is a diagram showing an example of architecture for a storage device of the present invention, co-operating with a host device.

The invention thus aims to enable a file system manager that is provided internally to a data storage device of the memory card type to be used with an external interface by implementing a data access protocol based on block read and block write commands.

As shown in FIG. 3, a storage device 10 of the invention includes a memory space 20 that is typically subdivided into memory blocks for data storage. The storage device incorporates an operating system supporting a file system manager 30 for organizing the memory blocks and for constructing a memory file system using a predefined structure, e.g. a file system of the FAT 16 type or of the FAT 32 type.

By means of the file system manager 30, the storage device thus has its own means for managing files internally, whereby the device can control access to its memory files and the rights of access to the files, typically through commands of the following types: “open file”, “read file” and “write file”. Managing the security of the data contained in the memory space 20 of the device is thus performed at the level of the data files using access rights that can be defined for each of them. Each file is thus associated with an access control list that stores the operations that third parties are authorized to execute on the file.

Such a storage device 10 is designed to cooperate with a host device 40, in which, for example, it is inserted. The host device 40 includes its own operating system, supporting means 50 that are normally designed to format the memory space of a storage device with which it co-operates in a defined arrangement, with a view to putting in place a file system making it possible to handle management and manipulation of data files in the memory. An application 60 of the host device can then use said file system for manipulating data on the storage device.

In the context of the present invention, having a file system put in place by the operating system of the host device 40 is based on management of the memory blocks of the storage device. Thus, the host device is designed to see the memory space of the storage device as a set of blocks, as shown in FIG. 1 (described above), with a view to using said memory for putting in place the file system through commands of the block type.

The interface between the host device 20 and the storage device 10 thus implements a protocol 70 that is conventionally based on a command format of the block type for reading and writing data blocks in the memory.

Such a host device 40 should not therefore be used with the storage device 10 because, since said storage device already manages its own file system, access to the memory and control of access to the data should be performed at the level of the data files through commands of the file type. The host device 40 cannot accommodate such a protocol.

In order to mitigate this incompatibility, and in accordance with the invention, the storage device 10 is then provided with a protocol conversion interface 80 in the form of an additional software layer under the control of the software layer 30 that handles management of the file system internal to the storage device. The function of the conversion interface 80 is thus to emulate an interface of the block type for the host device 40 by simulating a memory having bock-type access on the storage device, so that it is possible to use the storage device 10 having access of the file type with the host device 40 that is designed to manage access of the block type.

The protocol conversion interface 80 implemented in the storage device 10 thus makes it possible to simulate, for the environment outside the storage device and in particular for the host device in which the storage device is inserted, a block-type memory image of the files accessible by the host device, based on the logic organization of the file system internal to the storage device, and as a function of the access rights that are associated with the host device. Thus, only those files that are accessible by the host device as a function of its access rights are visible by the host device in the form of memory blocks.

The conversion interface 80 then handles translating the commands of the block type that are received from the host device 40 into commands of the file type for the file management means 30 internal to the storage device. In other words, the conversion interface 80 interprets the requests from the host device, which requests are in the form of block read/write commands so as to transform them into commands for the internal file system, i.e. typically into commands of the open file/create file/read file/write file type. Depending on the type of command message coming from the host device, the protocol conversion interface then, when appropriate, transmits a response of the block type from the internal file system management means to the host device.

As a result, the storage device can organize its file system by taking account of the access rights that are associated with the host device, and can thus control access at file level even when receiving access commands of the block type.

The storage device can also organize its file system by taking account of the specificities of the type of memory that is used. The conversion interface 80 advantageously makes it possible to virtualize the addresses of the memory blocks that are visible from the outside of the storage device so as to store said blocks at different physical addresses each time writing takes place. This aspect is particularly advantageous for Flash memory that withstands a limited number of erase/write cycles.

The exact implementation of the conversion interface 80 depends on the type of file system that is to be simulated for the host device.

Consideration is given below to an implementation example based on the most common case of a file system of the FAT type, resulting in construction of a memory of the block type in which various different zones are identified, among which there are, conventionally, a system zone with partition and boot sectors, a FAT zone, and file zones. Other file organization systems can also be contemplated without going beyond the ambit of the present invention.

For example, the conversion interface 80 performs the following operations. On receiving, from the host device, a read or write access request for reading from or writing in a memory block, said conversion interface firstly determines the type of block accessed, namely whether said block belongs to a system zone, to a FAT zone, or to a file zone. For this purpose, the conversion interface 80 uses the information on the formatting of the memory 20 that is available to it via the internal file system manager 30, and that describes the correspondence between the memory addresses and the various zones of the file system. Thus, on the basis of the address of the block accessed, the conversion interface deduces its type therefrom.

After this preliminary step, and depending on the type of block accessed and the action required, the interface 80 transmits a block-type response consisting in dynamically constructing a data block to be sent back to the host device, or in modifying its internal file structure to reflect the change required by the host device.

Thus, if, as a function of the memory address of the block, the block-type command received from the host device corresponds to a data read command for reading data from the system zone, the conversion interface sends back a constant block to the host device. Conversely, a block write command corresponding to writing data in the system zone is ignored by the conversion interface.

In order to respond to a block read command received from the host device and corresponding to reading data from the FAT, the processing applied by the conversion interface then consists in constructing the data of the table on the basis of the list of internal files through file-type commands sent to the internal file manager making it possible to access the corresponding data and to send the table to the host device, which table is then visible by said host device as a set of blocks. In addition, the table is constructed on the basis of the access rights of the host device since certain files might not be visible from the host device.

A block write command received from the host device corresponding to writing the FAT is translated by the conversion interface into a file-type command whose destination is the internal file manager, making it possible to update the internal file system (erase file, create, modify).

In order then to respond to a block read command received from the host device corresponding to reading of the data zone proper of the file system, the conversion interface must determine which file is accessed on the basis of the block number and of the FAT previously sent to the host device. The block read command is then translated by the conversion interface into a read command for reading the file portion concerned in the internal file system of the storage device, and the interface sends back the corresponding block to the host device, as modified, where appropriate, as a function of access rights associated with the host device.

A block write command received from the host device and corresponding to writing in the data zone of the file system is processed differently by the conversion interface depending on whether the block in question concerns a file that already exists or whether said block was not allocated previously. If the data block concerns a file that already exists, the conversion interface translates said block write command into an internal file modification command. Conversely, if the data block was not previously allocated, the conversion interface translates the block command into a command for creating a temporary file on the basis of the block. The temporary files are re-assembled during updating of the file allocation table by the host device.

The present invention thus makes it possible to manage the access rights at file level on storage devices equipped with internal file systems and that co-operate with host devices implementing memory access of the block-type. This possibility of enabling access to the memory and the use of said memory to be controlled at file level while also maintaining compatibility with host devices managing access in blocks opens up numerous application prospects. In particular, an example of an application of the present invention concerns controlling a storage device of the above-mentioned type used by a third party. In this type of configuration, the third party user can have the right to store data on the storage device, and to erase it, but said third party user can have access only to a portion of the data that said user has previously stored. Only the owner of the storage device enjoying the access rights can retrieve all of the stored data and can, for example, have this service paid for by the third party user of the storage device. By means of the format conversion interface that is provided in the storage device, this type of use is made possible without modifying the host device of the user of the storage device.

For example, the owner of the storage device might be a photograph printout service provider who supplies memory cards to users for storing their pictures. The user inserts the memory card into a host device of the digital camera type and can then use the memory to store photos. Internally to the card, each photo corresponds to a file, which can thus be processed and to which access can be controlled via the conversion interface implemented on the card. For example, if the user does not authenticate himself or herself as being authorized to have full access to the files, it is possible to have the card authorize access to the files for the host device only with intentionally modified or degraded quality (smaller format, with a banner added across the picture, etc.). Thus, only the printout service provider, after authentication from the card, can retrieve the files with their full quality and print them out for the user in consideration for a fee.

The present invention is designed to apply to all formats of memory card, whenever the card manages its own file system internally.

1. A data storage device comprising a memory space subdivided into memory blocks and management means for managing an internal file system organizing said memory blocks so as to store data in the form of a structure of files, said management means controlling access to the data in the memory using a file-type command format, wherein said data storage device further comprises a protocol conversion interface between said management means for managing the file system and a host device including means for accessing the data in the memory of said storage device using a block-type command format.

2. A storage device according to claim 1, wherein said protocol conversion interface includes means for acting on the basis of the logic organization of the internal file system to simulate a block-type memory image of the files that are accessible by said host device, said image being visible by said host device.

3. A storage device according to claim 1 wherein said protocol conversion interface includes means for translating block-type commands received from the host device into file-type commands whose destination is the management means for managing the file system.

4. A storage device according to claim 3, wherein the means for translating block-type commands into file-type commands include means for determining the type of block accessed from among a system zone, a File Allocation Table zone, and a file zone of the internal file system.

5. A storage device according to claim 3, wherein the protocol conversion interface includes means for transmitting firstly the translated block-type commands to the file system management means and secondly corresponding block-type responses to the host device.

6. A device according to claim 5, wherein the protocol conversion interface includes means for constructing the block-type responses as a function of access rights associated with the host device.

7. A device according to claim 1, wherein the protocol conversion interface includes means for modifying the data accessed by the host device as a function of the type of data accessed and/or of access rights associated with the host device.

8. A storage device according to claim 1, wherein the protocol conversion interface is in software form under the control of the file system management means.
